(19) United States
(12) Patent Application Publication
(10) Pub. No.: US 2015/0096631 A1
(43) Pub. Date: Apr. 9, 2015

(54) METHODS AND SYSTEMS FOR CHANNELING AIRCRAFT HYDRAULIC FLUID

(71) Applicant: THE BOEING COMPANY, Huntington Beach, CA (US)

(72) Inventor: Casey Charles Regan, Snohomish, WA (US)

(21) Appl. No.: 14/311,738

(22) Filed: Jun. 23, 2014

Related U.S. Application Data
(63) Continuation-in-part of application No. 13/922,748, filed on Jun. 20, 2013.

(51) Int. Cl. F16L 39/00; F15B 13/08; B64C 13/36

(52) U.S. Cl. CPC F16L 39/005; B64C 13/36; F15B 13/0807
USPC 137/565.01; 29/428; 285/120.1

(57) ABSTRACT

Methods and a fluid separation fitting for channeling hydraulic fluid in an aircraft are provided herein. The fluid separation fitting includes a first tube section and a second tube section. The first tube section includes a first end and a second end, and is configured to receive a first distribution line therethrough. The first distribution line is configured to channel fluid therethrough in a first direction. The first tube section is configured to be coupled to a second distribution line configured to channel fluid therethrough in an opposite second direction. The second distribution line circumscribes at least a portion of the first distribution line. The second tube section extends from the first tube section to channel fluid into or from the second distribution line via the first tube section.

### CROSS REFERENCE TO RELATED APPLICATION

This application is a continuation-in-part of U.S. application Ser. No. 13/922,748, filed Jun. 20, 2013, the disclosure of which is hereby incorporated by reference in its entirety.

### BACKGROUND

The present disclosure relates generally to hydraulic systems and, more particularly, to aircraft hydraulic fluid distribution lines.

Known aircraft hydraulic systems use a pressurized supply line to transport hydraulic fluid to a load, and a separate return line for returning the hydraulic fluid from the load back to a storage tank or reservoir. Known pressurized supply lines and return lines are fabricated with a wall thickness that is sufficient to withstand pressure differentials that may exist within the hydraulic system. Separate pressure and return lines may require extra space and hardware. In an aircraft, space is limited, and the additional hardware increases weight, part cost, and installation time. Additionally, pressure lines are generally unprotected and thus, may be susceptible to damage during handling and installation and may be thicker and heavier than necessary.

### BRIEF SUMMARY

In one aspect, a fluid separation fitting is provided that includes a first tube section and a second tube section. The first tube section includes a first end and a second end, and is configured to receive a first distribution line therethrough. The first distribution line is configured to channel fluid therethrough in a first direction. The first tube section is configured to be coupled to a second distribution line configured to channel fluid therethrough in an opposite second direction. The second distribution line circumscribes at least a portion of the first distribution line. The second tube section extends from the first tube section to channel fluid into or from the second distribution line via the first tube section.

In another aspect, a method of manufacturing a fluid separation fitting is provided. The method includes providing a first tube section having a first end and a second end, the first tube section configured to receive a first distribution line therethrough. The first distribution line is configured to channel fluid therethrough in a first direction. The first tube section is configured to be coupled to a second distribution line configured to channel fluid therethrough in an opposite second direction. The second distribution line circumscribes at least a portion of the first distribution line. The method also includes coupling a second tube section extending from the first tube section for channeling fluid into or from the second distribution line.

In yet another aspect, a hydraulic system is provided that includes a pump for pressurizing fluid, a manifold for distributing the pressurized fluid to at least one load, and a fluid distribution line fluidly coupled to the pump and the manifold. The fluid distribution line includes a first distribution line configured to channel the fluid in a first direction, a second distribution line configured to channel the fluid in an opposite second direction, said second distribution line concentrically aligned with and circumscribing said first distribution line, and a fluid separation fitting. The fluid separation fitting includes a first tube section and a second tube section. The first tube section includes a first end and a second end, and is configured to receive a first distribution line therethrough. The first distribution line is configured to channel fluid therethrough in a first direction. The first tube section is configured to be coupled to a second distribution line configured to channel fluid therethrough in an opposite second direction. The second distribution line circumscribes at least a portion of the first distribution line. The second tube section extends from the first tube section to channel fluid into or from the second distribution line via the first tube section.

### BRIEF DESCRIPTION OF THE DRAWINGS

FIG. 1 is a block diagram of an exemplary hydraulic system that may be used in an aircraft.

FIG. 2 is a perspective view of an exemplary fluid distribution system that may be used in the aircraft hydraulic system shown in FIG. 1.

FIG. 3 is an enlarged perspective view of the fluid distribution system shown in FIG. 2.

FIG. 4 is a perspective view of the fluid distribution system shown in FIG. 2 and coupled within the hydraulic system shown in FIG. 1.

FIG. 5 is an enlarged view showing connections of the fluid distribution system to the aircraft hydraulic system shown in FIG. 4.

FIG. 6 is a perspective view of an alternative fluid distribution system shown in FIG. 2 and coupled within the hydraulic system shown in FIG. 1.

FIG. 7 is a flow diagram of an exemplary aircraft production and service methodology.

FIG. 8 is a block diagram of an exemplary aircraft that may be fabricated using the system shown in FIG. 1.

FIG. 9 is a perspective view of an exemplary fluid separation fitting that may be used with the fluid distribution system shown in FIGS. 2 and 3.

FIG. 10 is a perspective view of an alternative second tube section of the fluid separation fitting shown in FIG. 9.

FIG. 11 is a perspective view of an alternative first tube section that may be used with the second tube section shown in FIG. 9.

### DETAILED DESCRIPTION

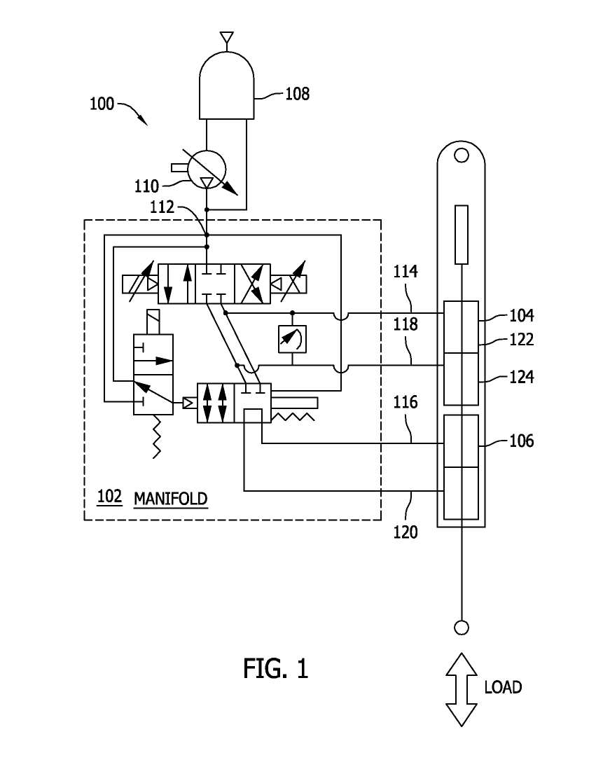

FIG. 1 is a block diagram of an exemplary hydraulic system 100 that may be used in an aircraft. Hydraulic system 100 includes a manifold 102, a first actuator 104, and a second actuator 106. Manifold 102 is in flow communication to a pressure source (not shown) that includes a fluid reservoir 108 and a pump 110 that supply manifold 102 with a pressurized working fluid via a fluid distribution system 112. Pump 110 may include any type of pump, such as, but not limited to, hydraulic pumps, engine driven pumps, electrically driven pumps, air or wind driven pumps, and/or ram air turbine (RAT) pumps. The working fluid is returned back to fluid reservoir 108 at the reservoir pressure via fluid distribution system 112. From the reservoir 108, the working fluid is then re-supplied to pump 110 via fluid distribution system 112. Accordingly, hydraulic system 100 constitutes a closed fluid system.

First and second actuators 104 and 106, respectively, may include any actuators used in known hydraulic systems. Each actuator 104 and 106, respectively, includes a piston (not shown) movable within an actuator barrel (not shown). Each actuator 104 and 106, respectively, also includes a shaft or rod (not shown). One end of the shaft engages the piston, while the other end of the shaft engages with the flight control surface. The actuator barrel is in flow communication to fluid reservoir 108 and to pump 110 via an extended fluid conduit 114 or 116 and a retracted fluid conduit 118 or 120. Each actuator barrel is sized to enable the piston to move within the barrel when the barrel receives a supply of pressurized working fluid from reservoir 108 and pump 110 via fluid distribution system 112.

Each actuator 104 and 106 is in flow communication to manifold 102 via a respective extended fluid conduit or line 114 or 116, respectively, and via a retracted fluid conduit 118 or 120. When provided with pressurized working fluid, the flow direction of the pressurized working fluid determines whether actuators 104 and 106 extend or retract, and thus operate to retract or extend the flight control surface. For example, first actuator's 104 piston extends when the pressurized working fluid enters an extend side 122 of first actuator 104 via extended fluid conduit 114. Working fluid is discharged from a retract side 124 of first actuator 104 via retracted fluid conduit 118 and is returned to reservoir 108 via fluid distribution system 112. Conversely, first actuator's 104 piston retracts when the pressurized working fluid is provided to retract side 124 via retracted fluid conduit 118. In such a condition, the working fluid is discharged from extend side 122 of first actuator 104 via extended fluid conduit 114 and returned to reservoir 108 via fluid distribution system 112.

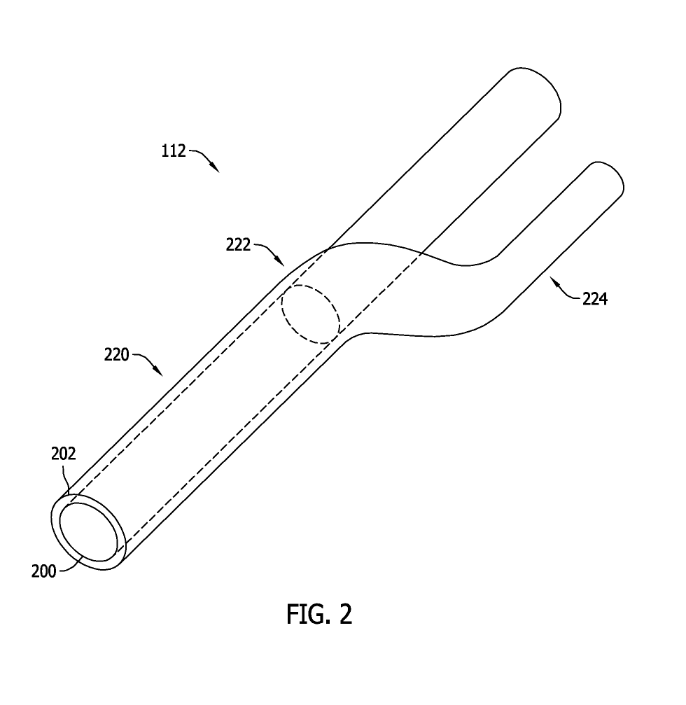

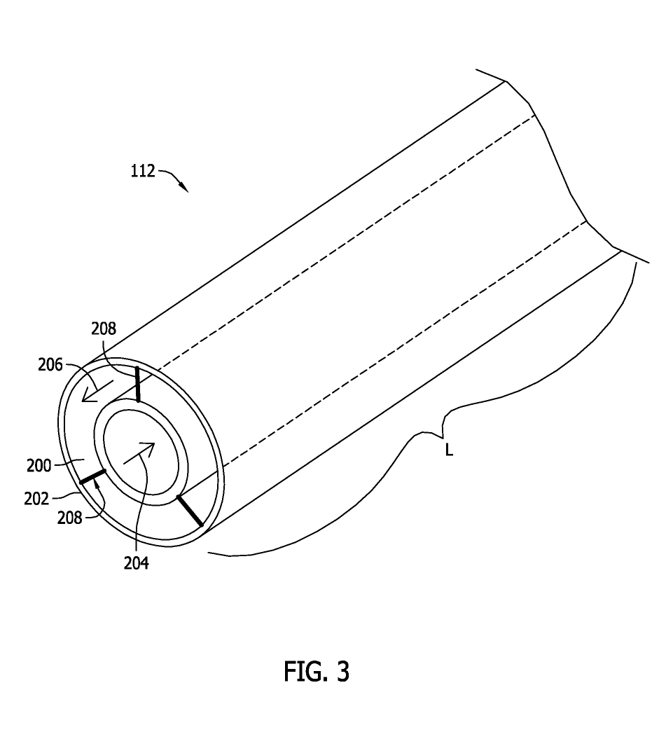

FIG. 2 is a perspective view of an exemplary fluid distribution system 112, and FIG. 3 is an enlarged perspective view of fluid distribution system 112 that may be used in aircraft hydraulic system 100 (shown in FIG. 1). In the exemplary implementation, fluid distribution system 112 includes a first, inner line 200 and a second, outer line 202. Outer line 202 includes a first portion 220, a second portion 224, and an interface portion 222 located therebetween. Inner line 200 extends in a substantially linear direction and is sized for insertion into outer line 202 at interface region 222. More specifically, inner line 200 is insertable into outer line 202 with an interference fit at interface region 222, and is substantially concentric with first portion 220. Second portion 224 then extends transversely from interface region 222 to couple in flow communication with fluid reservoir 108 (shown in FIG. 1).

Inner line 200 is concentrically positioned within outer line 202 along a full length L of fluid distribution system 112. More specifically, outer line 202 is radially outward from inner line 200. Fluid distribution system 112 is configured to channel a fluid in a first direction 204 via inner line 200 and channel fluid in a second direction 206 that is opposite first direction 204 via outer line 202.

In the exemplary implementation, inner line 200 is a pressure supply line 200 that delivers pressurized working fluid to manifold 102 (shown in FIG. 1). Further, in the exemplary implementation, outer line 202 is a return line 202 that returns the working fluid to fluid reservoir 108 (shown in FIG. 1). Because return line 202 circumferentially surrounds pressure supply line 200, at least a portion of hoop stresses induced to pressure supply line 200 are reduced, thus enabling pressure supply line 200 to be fabricated with a thinner wall thickness than other known pressure supply lines. In some implementations, one or more internal support members 208 extend between pressure supply line 200 and return line 202 to provide enhanced structural support and to facilitate preventing bending and/or disfigurement of fluid distribution system 112. In an alternative implementation, return line 202 may be concentrically positioned within pressure supply line 200.

In the exemplary embodiment, fluid distribution system 112 is fabricated using an additive manufacturing process. Specifically, an additive manufacturing process known as direct metal laser sintering (DMLS) or direct metal laser melting (DMLM) is used to manufacture fluid distribution system 112. Although the fabrication process is described herein as DMLS, one having ordinary skill in the art would understand that DMLM could also be used. Alternatively, the additive manufacturing method is not limited to the DMLS or DMLM process, but may be any known additive manufacturing process that enables fluid distribution system 112 to function as described herein. This fabrication process eliminates complex joints and structures that would typically be defined between separate components that require welding or brazing. Rather, DMLS is an additive layer process that produces a metal component directly from a CAD model using a laser and a fine metal powder. The result is a monolithic distribution system having concentric first and second distribution lines connected by support members. The distribution system may further include ducts that extend from the first and second distribution lines that are configured to couple with separate fluid sources. In a further implementation, the ducts may also be manufactured in-situ with the distribution system using a DMLS, DMLM, or other additive manufacturing process to form a monolithic distribution system. In the exemplary implementation, aluminum-based alloy powders, corrosion resistant steel-based alloy powders, titanium-based alloy powders, and synthetic rubber compound powders are used to fabricate the fluid distribution line disclosed herein, but other powders that enable the fluid distribution line to function as described herein may be used.

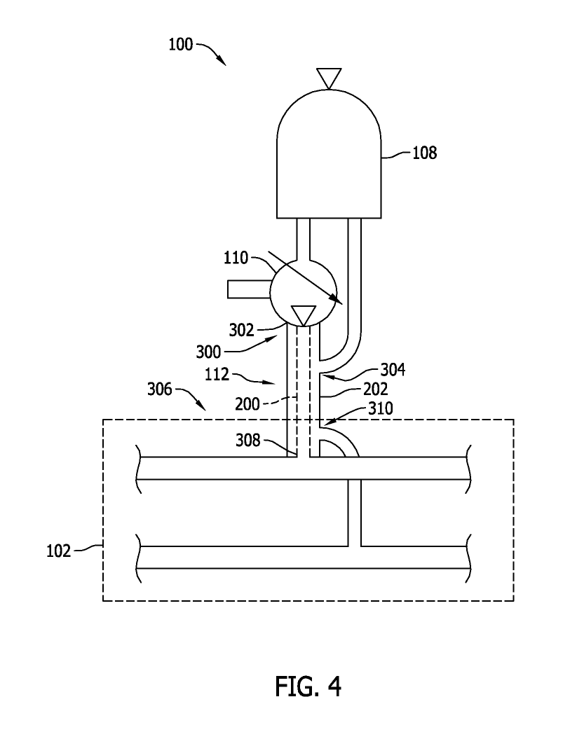

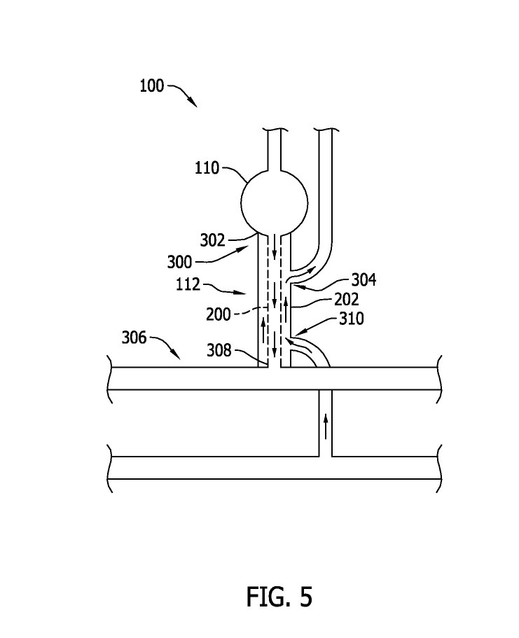

FIG. 4 is a perspective view of a fluid distribution system 112 (shown in FIG. 2) that is coupled within hydraulic system 100 (shown in FIG. 1). FIG. 5 is an enlarged view showing connection of fluid distribution system 112 to aircraft hydraulic system 100. In the exemplary implementation, at a first end 300, pressure supply line 200 is in flow communication to pump 110 (shown in FIG. 1). Return line 202 extends about pressure supply line 200 and is coupled to an end plate 302 of pump 110. Return line 202 includes an outlet 304 that is coupled in flow communication to reservoir 108 to channel fluid returning from manifold 102 back into reservoir 108.

In the exemplary implementation, at a second end 306, pressure supply line 200 is coupled in flow communication to an inlet 308 of manifold 102 to enable fluid flow of pressurized fluid from pump 110 into manifold 102. Further, fluid distribution system 112 includes a return line inlet 310 that channels fluid flowing from manifold 102 back towards reservoir 108. In alternative implementations, fluid distribution system 112 may be coupled within system 100 using a separate connection device than the device that couples fluid distribution system 112 to system 100.

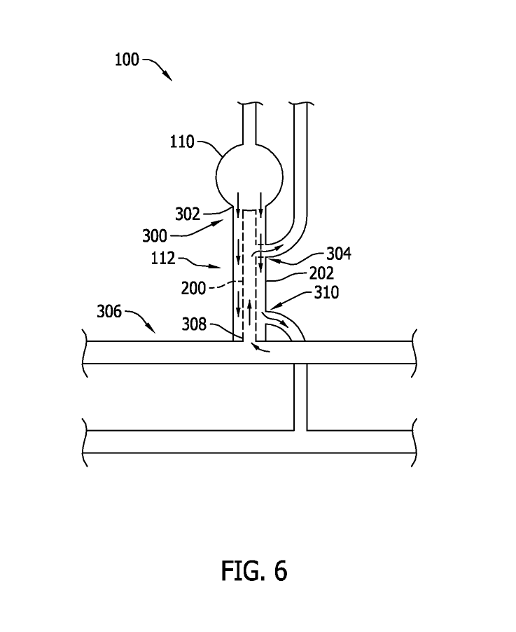

FIG. 6 is a perspective view of an alternative fluid distribution system shown in FIG. 2 and coupled within the hydraulic system shown in FIG. 1. The distribution system may include ducts that extend from the first and second distribution lines that are configured to connect with separate fluid sources. The system may be structured such that a duct that is coupled in flow communication with the first distribution line extends through a wall of the second distribution line to couple in flow communication with fluid reservoir 108 (shown in FIG. 1). Further, the wall of the second distribution line and the duct may be manufactured in-situ with the distribution system using a DMLS, DMLM, or other additive manufacturing process to form a monolithic distribution system.

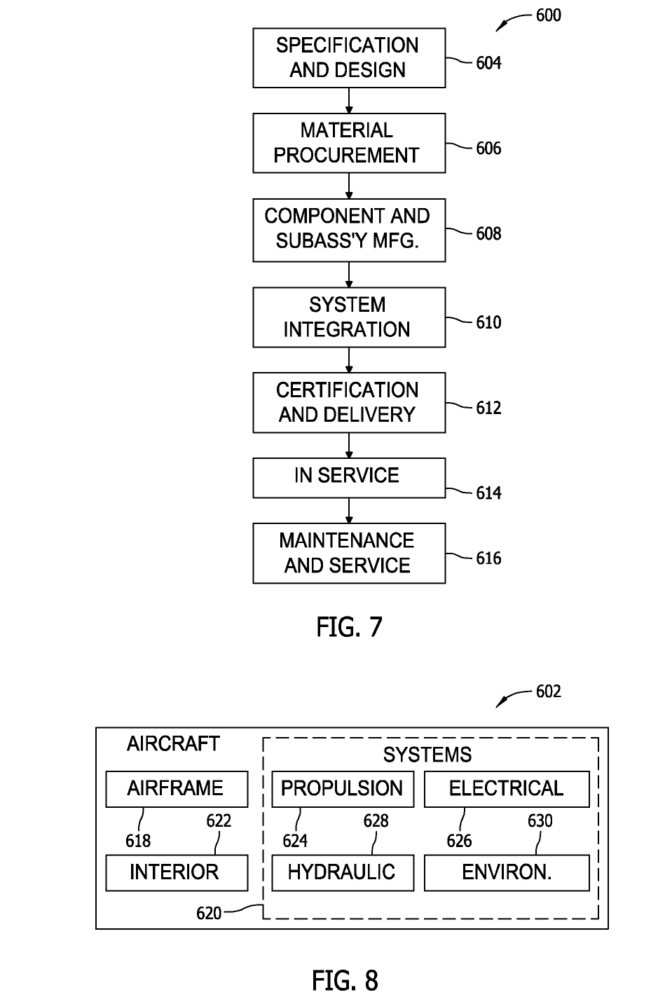

The methods and systems described herein are in the context of aircraft manufacturing and service method 600 (shown in FIG. 7) and an aircraft 602 (shown in FIG. 8). Alternatively, the methods and systems described herein may be implemented in any context and/or in any environment involving a fluid distribution system. During pre-production, method 600 may utilize specification and design 604 of the aircraft 602 and/or material procurement 606. During production, component and subassembly manufacturing 608 and system integration 610 of the aircraft 602 occurs. Thereafter, aircraft 602 may go through certification and delivery 612 prior to being placed in service 614. While in service by a customer, aircraft 602 is scheduled for routine maintenance and service 616 (including, for example, modification, reconfiguration, and/or refurbishment).

Each of the processes of method 600 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

As shown in FIG. 8, an aircraft 602 produced using method 600 may include an airframe 618 having a plurality of systems 620 and an interior 622. Examples of high-level systems 620 may include one or more of a propulsion system 624, an electrical system 626, a hydraulic system 626, and/or an environmental system 630. Any number of other systems may be included. Although an aerospace example is shown, the principles of the invention may be applied to other industries, such as the automotive industry, machinery, and heavy equipment.

Apparatus and methods embodied herein may be employed during any one or more of the stages of the production and service method 600. For example, components or subassemblies corresponding to production process 608 may be fabricated or manufactured in a manner similar to components or subassemblies produced while the aircraft 602 is in service. Also, one or more apparatus implementations, method implementations, or a combination thereof may be utilized during the production stages 608 and 610, for example, by substantially expediting assembly of or reducing the cost of an aircraft 602. Similarly, one or more of apparatus implementations, method implementations, or a combination thereof may be utilized while the aircraft 602 is in service, for example and without limitation, to maintenance and service 616.

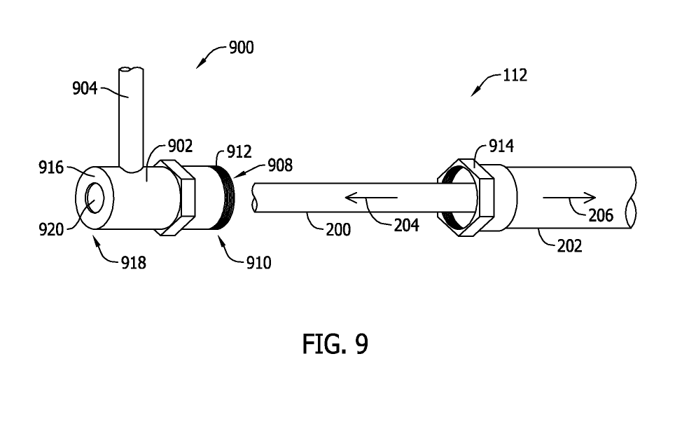

FIG. 9 is a perspective view of an exemplary fluid separation fitting 900 that may be used with fluid distribution system 112 (shown in FIGS. 2 and 3). In the exemplary implementation, fluid separation fitting 900 is configured to separate inner line 200 (shown in FIG. 2) from outer line 202 (shown in FIG. 2). Fluid separation fitting 900 is manufactured using a subtractive manufacturing process or any other manufacturing process that enables fluid separation fitting to function as described herein. Fluid separation fitting 900 includes a first tube section 902 and a second tube section 904.

In the exemplary implementation, first tube section 902 is configured to receive inner line 200 therethrough. Inner line 200 is configured to channel fluid therethrough in a first direction 204 (shown in FIG. 2). First tube section 902 is configured to be coupled to outer line 202 configured to channel fluid therethrough in an opposite second direction 206 (shown in FIG. 2). Outer line 202 circumscribes at least a portion of inner line 200. First tube section 902 includes a connection device 908 positioned at a first end 910 of first tube section 902 for coupling fluid separation fitting 900 to outer line 202. In the exemplary implementation, connection device 908 is a threaded male portion 912 configured to couple to a threaded female portion 914 on outer line 202. Alternatively, connection device 908 may be any type of connection device that enables fluid separation fitting 900 to function as described herein. First tube section 902 also includes a flange 916 positioned at a second end 918 of first tube section 902. Flange 916 defines an aperture 920 configured to receive inner line 200 therethrough.

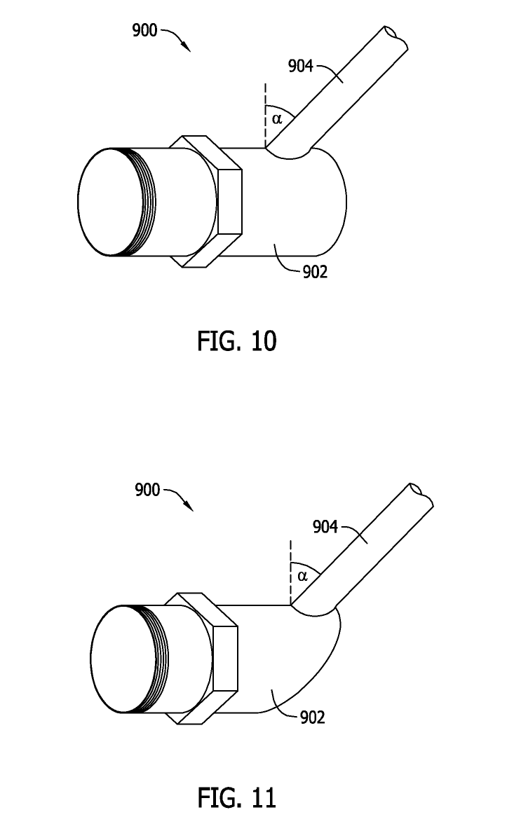

In the exemplary implementation, second tube section 904 extends radially outward from first tube section 902. Second tube section 904 is in flow communication with first tube section 902 and is configured to channel fluid into or from outer line 202 via first tube section 902. In the exemplary implementation, second tube section 904 extends from first tube section 902 at a substantially perpendicular angle. In another implementation, as shown in FIG. 10, second tube section 904 extends from first tube section 902 at an angle a to facilitate improving fluid flow from second tube section 904 into outer line 202. In another implementation, as shown in FIG. 11, second end 918 of first tube section 902 extends at the same angle a at which second tube section 904 extends from first tube section 902.

Referring back to FIG. 9, in the exemplary implementation, first tube section 902 is concentrically aligned with and circumscribes at least a portion of inner line 200 over a length L1 of first tube section 902. Beyond length L1, inner line 200 extends longitudinally from first tube section 902 in first direction 204 and is no longer circumscribed by first tube section 902.

The embodiments described herein facilitate reducing the size and space required for installation of fluid distribution lines in an aircraft. More specifically, the above-described systems integrate a pressure supply line within a return line, rather than having separate lines that require more space. The return line reduces stresses on and protects the pressure supply line during installation and operation, enabling a reduction in thickness of the pressure supply line. Further, the above-described fluid distribution line reduces weight, installation time, and costs.

A technical effect of the systems and methods described herein includes at least one of: (a) providing a first tube section having a first end and a second end, the first tube section configured to receive a first distribution line therethrough, wherein the first distribution line is configured to channel fluid therethrough in a first direction, the first tube section configured to be coupled to a second distribution line configured to channel fluid therethrough in an opposite second direction, wherein the second distribution line circumscribes at least a portion of the first distribution line; and (b) coupling a second tube section extending from the first tube section for channeling fluid into or from the second distribution line.

The implementations described herein relate generally to hydraulic systems and, more particularly, to methods and systems for channeling a fluid using aircraft hydraulic fluid distribution lines. Exemplary implementations of methods and systems for channeling a fluid using aircraft hydraulic fluid distribution lines are described above in detail. The methods and systems are not limited to the specific implementations described herein, but rather, components of systems and/or steps of the method may be utilized independently and separately from other components and/or steps described herein. Each method step and each component may also be used in combination with other method steps and/or components. Although specific features of various implementations may be shown in some drawings and not in others, this is for convenience only. Any feature of a drawing may be referenced and/or claimed in combination with any feature of any other drawing.

An element or step recited in the singular and proceeded with the word “a” or “an” should be understood as not excluding plural elements or steps unless such exclusion is explicitly recited. Moreover, references to “one implementation” of the present invention and/or the “exemplary implementation” are not intended to be interpreted as excluding the existence of additional implementations that also incorporate the recited features.

This written description uses examples to disclose the implementations, including the best mode, and also to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fluid separation fitting comprising:
a first tube section comprising a first end and a second end, said first tube section configured to receive a first distribution line therethrough, wherein the first distribution line is configured to channel fluid therethrough in a first direction, said first tube section configured to be coupled to a second distribution line configured to channel fluid therethrough in an opposite second direction, wherein the second distribution line circumscribes at least a portion of the first distribution line; and
a second tube section extending from said first tube section for channeling fluid into or from the second distribution line.

2. A fluid separation fitting in accordance with claim 1, wherein said first tube section further comprises a connection device positioned at said first end for coupling said fluid separation fitting to the second distribution line.

3. A fluid separation fitting in accordance with claim 1, wherein said first tube section further comprises a flange coupled to said second end of said first tube section, said flange defining an aperture configured to receive the first distribution line therethrough.

4. A fluid separation fitting in accordance with claim 1, wherein said second tube section extends from said first tube section at an angle to increase fluid flow from said second tube section into the second distribution line.

5. A fluid separation fitting in accordance with claim 4, wherein said second end of said first tube section extends at the same angle at which said second tube section extends from said first tube section.

6. A fluid separation fitting in accordance with claim 1, wherein said fluid separation fitting is manufactured using a subtractive manufacturing process.

7. A fluid separation fitting in accordance with claim 1, wherein said first tube section is concentrically aligned with the first distribution line over a distance.

8. A fluid separation fitting in accordance with claim 1, wherein said first tube section circumscribes at least a portion of the first distribution line over a distance.

9. A fluid separation fitting in accordance with claim 8, wherein the first distribution line extends longitudinally from said first tube section in the first direction beyond the distance, and is no longer circumscribed by said first tube section.

10. A method of manufacturing a fluid separation fitting, said method comprising:
providing a first tube section having a first end and a second end, the first tube section configured to receive a first distribution line therethrough, wherein the first distribution line is configured to channel fluid therethrough in a first direction, the first tube section configured to be coupled to a second distribution line configured to channel fluid therethrough in an opposite second direction, wherein the second distribution line circumscribes at least a portion of the first distribution line; and
coupling a second tube section extending from the first tube section for channeling fluid into or from the second distribution line.

11. A method in accordance with claim 10, further comprising forming a connection device at the first end of the first tube section for coupling the fluid separation fitting to the second distribution line.

12. A method in accordance with claim 10, further comprising forming a flange at the second end of the first tube section, wherein the flange defines an aperture configured to receive the first distribution line therethrough.

13. A method in accordance with claim 10, further comprising extending the second tube section at an angle from the first tube section to increase fluid flow from the second tube section into the second distribution line.

14. A method in accordance with claim 13, further comprising extending the second end of the first tube section at the same angle at which the second tube section extends from the first tube section.

15. A method in accordance with claim 10, wherein the fluid separation fitting is manufactured using a subtractive manufacturing process.

16. A hydraulic system comprising:
a pump for pressurizing fluid;
a manifold for distributing the pressurized fluid to at least one load; and
a fluid distribution line fluidly coupled to said pump and said manifold, said hydraulic fluid distribution line comprising:
a first distribution line configured to channel the fluid in a first direction;
a second distribution line configured to channel the fluid in an opposite second direction, said second distribution line concentrically aligned with and circumscribing said first distribution line; and
a fluid separation fitting comprising:
a first tube section having a first end and a second end, the first tube section configured to receive said first distribution line therethrough, said first tube section configured to be coupled to said second distribution line; and
a second tube section extending from said first tube section for channeling fluid into or from said second distribution line.

17. A system in accordance with claim 16, wherein said first tube section further comprises a connection device positioned at said first end for coupling said fluid separation fitting to the second distribution line.

18. A system in accordance with claim 16, wherein said first tube section further comprises a flange coupled to said second end of said first tube section, said flange defining an aperture configured to receive the first distribution line therethrough.

19. A system in accordance with claim 16, wherein said second tube section extends from said first tube section at an angle to increase fluid flow from said second tube section into the second distribution line.

20. A system in accordance with claim 19, wherein said second end of said first tube section extends at the same angle at which said second tube section extends from said first tube section.
